(19) United States
(12) Patent Application Publication
(10) Pub. No.: US 2004/0109308 A1
(43) Pub. Date: Jun. 10, 2004

(54) Device for fixing layers of optic film of backlight module

(76) Inventor: Yi-Chun Ho, Chung-Ho City (TW)

Correspondence Address: SUPREME PATENT SERVICES, POST OFFICE BOX 2339, SARATOGA, CA, 95070, US

(21) Appl. No.: 10/313,836

(22) Filed: Dec. 7, 2002

(51) Int. Cl. F21V 7/04

(52) U.S. Cl. 362/97; 362/433; 362/455; 349/65

(57) ABSTRACT

A backlight module includes an illuminating unit or a light source positioned opposite to and confronting a substrate with an optic film comprised of a number of layers positioned between the illuminating unit and the substrate. A device for fixing the layers of the optic film together during a test process includes a clip having pawls that are spring biased to tightly engage opposite sides of the film thereby fixing the layers together. Alternatively, a retention member is positioned on the optic film opposite to the substrate. A pin extends between the retention member and the substrate and through aligned openings defined in the layers to fix the layers together. The pin may be integrally formed with the retention member or the pin extends from the substrate. Secondary pins extend from the substrate and engage corresponding counterpart elements formed on the retention member to mount the retention member to the substrate. In either case, no adhesive is adapted to fix the layers together and no residual of adhesive may be left between the layers.

### FIELD OF THE INVENTION

The present invention relates generally to the field of optic backlight modules, and in particular to a device for fixing layers of an optic film of a backlight module without adhesive materials for enhancing the manufacturing of the backlight modules.

### BACKGROUND OF THE INVENTION

Backlight modules are important parts of a number of opto-electrical devices. The backlight module comprises a substrate and a planar light source between which a multi-layer film is interposed. Layers of the film are fixed together by adhesives or adhesive tapes. Several drawbacks are commonly observed in the multi-layer film formed by means of adhesives or adhesive tapes. For example, one of the most concerned issues in the test of the film formed by adhesives is the so-called “waving issue”. The adhesive that are sandwiched between two layers of the film degrades when it is subject to heat and pressure in a test process. The degradation of the adhesive induces deformation of the films, leading to waving of local areas of the film. Further, the adhesive changes its shape when it is subject to heat and pressure, causing non-uniform displacement between layers of the film. In addition, the adhesives that are sandwiched between layers of the film cannot be completely removed after the test process. This results in residual of the adhesives on the film that in turn increases flaw rate of the final products. Besides, rework of the film is very difficult because of the degradation of the adhesives caused by heating and pressurizing.

Further, deformation of the adhesives leads to deformation of the layers of the film or changes spatial relationship between layers. Newtonian ring may thus be induced on the film due to the deformation or displacement of the layers of the film.

### SUMMARY OF THE INVENTION

Thus, an object of the present invention is to provide a device for fixing layers of a multi-layer optic film together without use of adhesives, whereby waving and non-uniform displacement of the layers caused by degradation of the adhesives are overcome.

Another object of the present invention is to provide a device for fixing layers of a multi-layer optic film that allows for ready rework of a product incorporating the optic film.

A further object of the present invention is to provide a device for fixing layers of a multi-layer optic film without inducing Newtonian ring.

Yet a further object of the present invention is to provide a device for fixing layers of a multi-layer optic film that reduces flaw rate of final products incorporating the optic films.

To achieve the above objects, in accordance with the present invention, a backlight module comprises an illuminating unit or a light source positioned opposite to and confronting a substrate with an optic film comprised of a number of layers positioned between the illuminating unit and the substrate. A device for fixing the layers of the optic film together during a test process comprises a clip having pawls that are spring biased to tightly engage opposite sides of the film thereby fixing the layers together. Alternatively, a retention member is positioned on the optic film opposite to the substrate. A pin extends between the retention member and the substrate and through aligned openings defined in the layers to fix the layers together. The pin may be integrally formed with the retention member or the pin extends from the substrate. Secondary pins extend from the substrate and engage corresponding counterpart elements formed on the retention member to mount the retention member to the substrate. In either case, no adhesive is adapted to fix the layers together and no residual of adhesive may be left between the layers.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a backlight module comprising a multi-layer optic film having layers fixed by a device constructed in accordance with a first embodiment of the present invention;

FIG. 1A is an enlarged view of encircled portion 1A of FIG. 1;

FIG. 2 is an exploded view of a backlight module comprising a multi-layer film having layers fixed by a device constructed in accordance with a second embodiment of the present invention;

FIG. 2A is an enlarged view of the encircled portion 2A of FIG. 2;

FIG. 3 is an exploded view of a backlight module comprising a multi-layer film having layers fixed by a device constructed in accordance with a third embodiment of the present invention;

FIG. 3A is an enlarged view of the encircled portion 3A of FIG. 3;

FIG. 4 is an assembled view of FIG. 3;

FIG. 4A is an enlarged view of encircled portion 4A of FIG. 4; and

FIG. 5 is a cross-sectional view of a portion of the device in accordance with the third embodiment of the present invention.

### DETAILED DESCRIPTION OF THE INVENTION

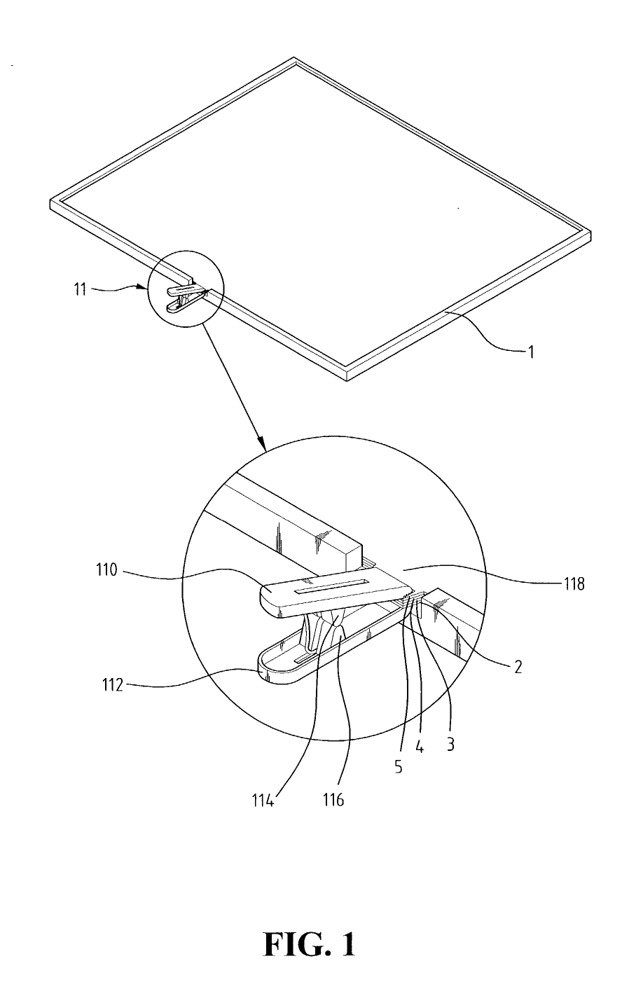

With reference to the drawings and in particular to FIGS. 1 and 1A, a backlight module comprises an illuminating unit 1 for illuminating a light valve (not shown) of an opto-electrical device. The illuminating unit 1 comprises a planar light source (not shown) and a substrate confronting the planar light source and comprised of a multi-layer optic film. The optic film comprises a number of layers 2, 3, 4, 5 positioned between the substrate and the planar light source for processing the light emitted from the planar light source. This is known and constitutes no novel part of the invention. Thus, no further details will be given herein. The layers 2, 3, 4, 5 are divided into local areas of different transmittance that are distributed in such a way to allow for uniform transmission of the light. It is noted that the number of the layers 2-5 can be varied in accordance with different applications, but the optic film comprises at least one layer 2.

A fixing device 11 comprises a clip fixing the layers 2-5 together in a test process. Since the adhesives that are conventionally used are replaced by the clip 11, problems associated with adhesives encountered heretofore are completely eliminated. Reliability and reusability of the optic film are thus enhanced.

The clip 11 comprises two pawls 110, 112 having projections 114, 116 engaging each other to function as a hinge between the pawls 110, 112 whereby the pawls 110, 112 are resiliently biased to rotate about the hinge for tightly engaging opposite sides of the optic film and thus fixing the layers 2-5 together in the test process.

Preferably, a slot 118 is defined through the layers 2-5 of the film for partial extension of the pawls 110, 112 therein to more securely fix the layers 2-5 together.

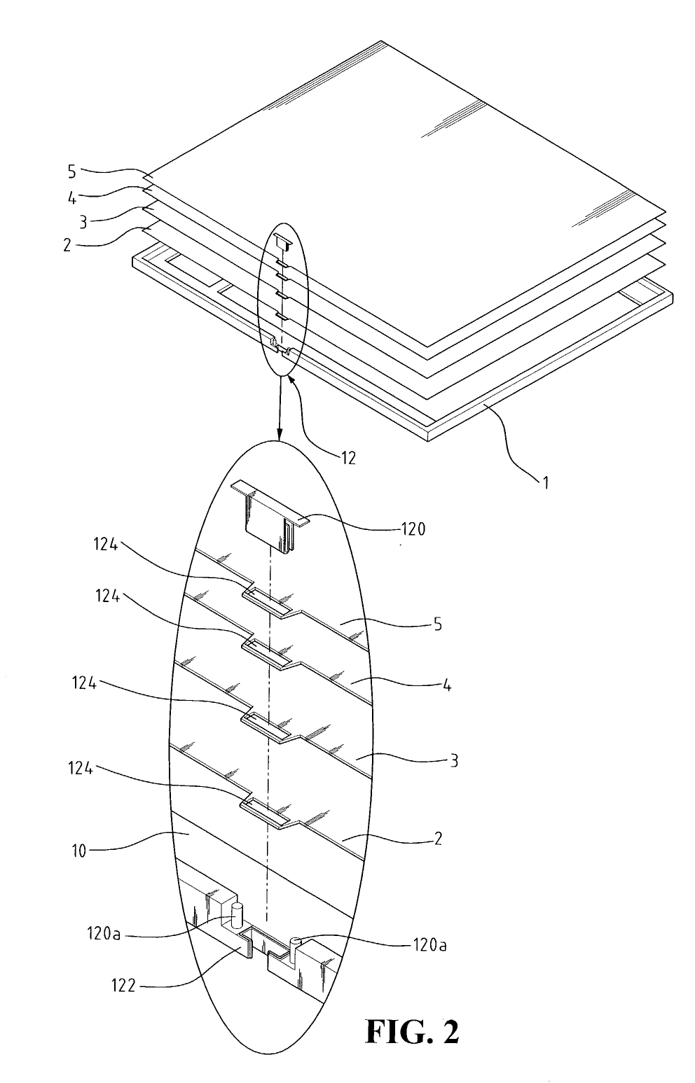

FIGS. 2 and 2A show a second embodiment in accordance with the present invention. The backlight module in accordance with the second embodiment comprises an illuminating unit 1 for illuminating a light valve (not shown). The illuminating unit 1 comprises a planar light source (not shown) and a substrate 10 confronting the planar light source and comprised of a multi-layer optic film. The optic film comprises a number of layers 2, 3, 4, 5 positioned between the substrate 10 and the light source for processing the light emitted from the planar light source. The layers 2, 3, 4, 5 are divided into local areas of different transmittance that are distributed in such a way to allow for uniform transmission of the light. It is noted that the number of the layers 2-5 can be varied in accordance with different applications, but the optic film comprises at least one layer 2.

A fixing device 12 for fixing the layers 2-5 together in accordance with the second embodiment comprises a locking block or a pin 120 sized to snugly extend through aligned slots 124 defined in the layers 2-5. The block 120 has opposite first and second ends. Side tabs (not labeled) extend in opposite directions from the first end of the block 120. The second end of the block 120 extends into a cutoff 122 defined in the substrate 10. Securing pins 120a are formed on opposite sides of the cutoff 122 for engaging corresponding counterpart securing elements (not shown) formed on the side tabs to securely fix the locking block 120 to the substrate 10 thereby fixing the layers 2-5 together between the side tabs of the locking block 120 and the substrate 10.

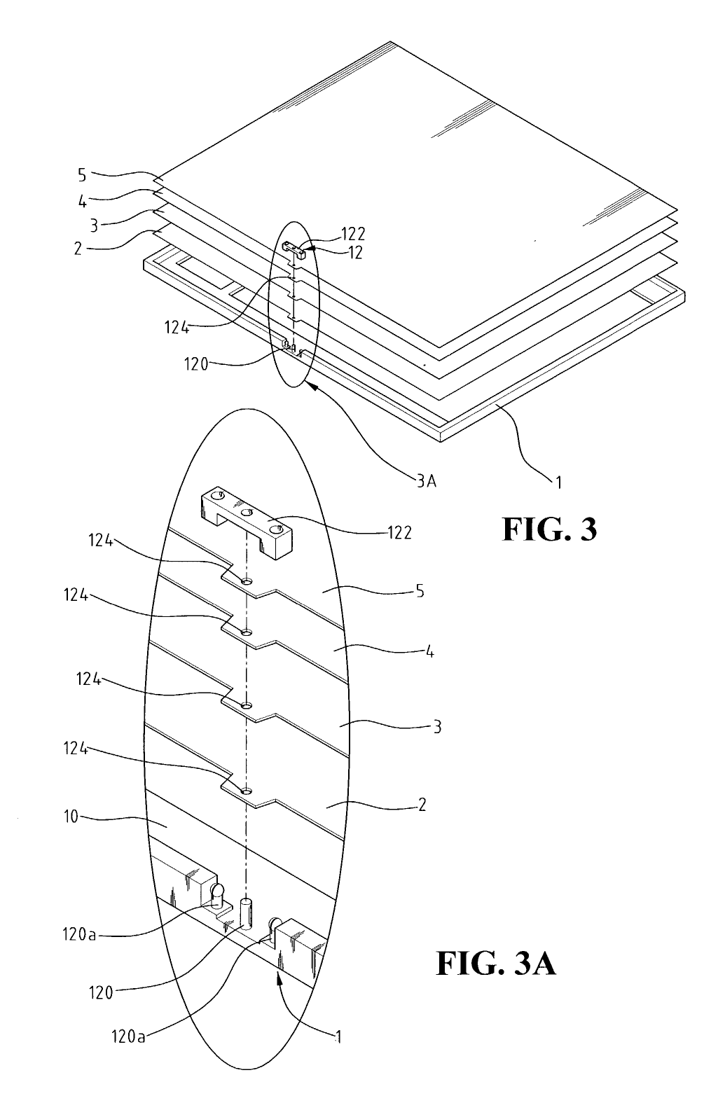

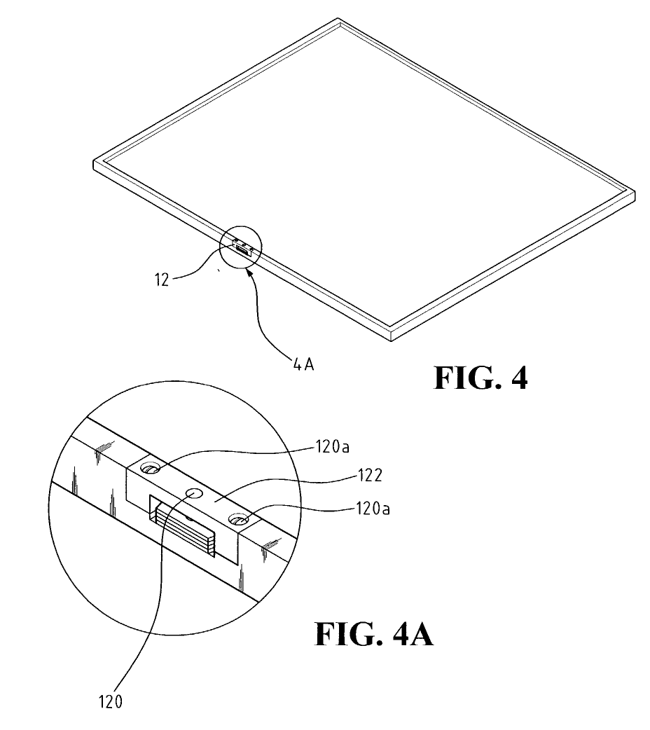

FIGS. 3, 3A, 4, 4A and 5 show a third embodiment in accordance with the present invention. The backlight module in accordance with the third embodiment comprises an illuminating unit 1 for illuminating a light valve (not shown). The illuminating unit 1 comprises a planar light source (not shown) and a substrate 10 confronting the planar light source and comprised of a multi-layer optic film. The optic film comprises a number of layers 2, 3, 4, 5 positioned between the substrate 10 and the light source for processing the light emitted from the planar light source. The layers 2, 3, 4, 5 are divided into local areas of different transmittance that are distributed in such a way to allow for uniform transmission of the light. It is noted that the number of the layers 2-5 can be varied in accordance with different applications, but the optic film comprises at least one layer 2.

A fixing device 12 for fixing the layers 2-5 together in accordance with the second embodiment comprises a pin 120 extending from the substrate 10 and through aligned holes 124 defined in the layers 2-5 and a retention block 122 positioned on the layers 2-5 opposite to the substrate 10. The retention block 122 defines a central hole (not labeled) to partially receive a free end of the pin 120 therein.

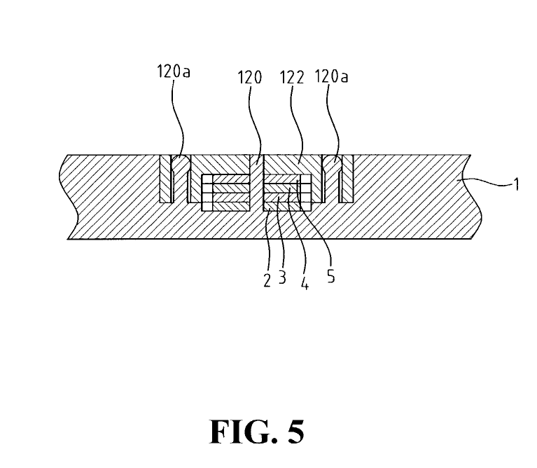

Secondary pins 120a are arranged on opposite sides of the pin 120 and have expanded free ends (see FIG. 5) tightly fit into openings defined in the retention block 122 to securely mount the retention block 122 to the substrate 10 and thus fixing the layers 2-5 together between the retention block 122 and the substrate 10.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. In a backlight module comprising an illuminating unit confronting a substrate with an optic film comprised of a number of layers positioned between the illuminating unit and the substrate, a device for fixing the layers of the optic film together comprising a clip comprising two pawls respectively engaging opposite sides of the optic film to fix the layers together.

2. The device as claimed in claim 1, wherein the pawls have projections engaging each other to function as a hinge about which the pawls rotate.

3. The device as claimed in claim 1, wherein the pawls are resiliently biased to tightly fix the layers together.

4. The device as claimed in claim 1, wherein aligned openings are defined in the layers for partially receiving the pawls therein.

5. In a backlight module comprising an illuminating unit confronting a substrate with an optic film comprised of a number of layers positioned between the illuminating unit and the substrate, a device for fixing the layers of the optic film together comprising a first member positioned on opposite side of the optic film with respect to the substrate, a second member extending between the first member and the substrate through aligned openings defined in the layers to fix the layers together.

6. The device as claimed in claim 5, wherein the second member comprises a pin extending from the substrate and has a free end received in a hole defined in the first member.

7. The device as claimed in claim 6, wherein secondary pins extend from the substrate and have ends tightly engaging corresponding openings defined in the first member to securely mount the first member to the substrate.

8. The device as claimed in claim 5, wherein the second member comprises a projecting block extending from the first member and extending though the aligned openings defined in the layers and partially received in a slot defined in the substrate.

9. The device as claimed in claim 8, wherein pins extend from the substrate and have ends tightly engaging corresponding elements formed in the first member to securely mount the first member to the substrate.
